(19) United States
(12) Patent Application Publication
(10) Pub. No.: US 2013/0157728 A1
(43) Pub. Date: Jun. 20, 2013

(54) METHOD FOR CONTROLLING A PORTABLE APPARATUS USED IN A TELECOMMUNICATION NETWORK, AND ASSOCIATED PORTABLE APPARATUS

(71) Applicant: Xu-tong Hu, Hefei City (CN)

(72) Inventor: Xu-tong Hu, Hefei City (CN)

(21) Appl. No.: 13/582,457

(22) PCT Filed: Dec. 14, 2011
(86) PCT No.: PCT/CN11/83974

§ 371 Date: Sep. 4, 2012

(51) Int. Cl. H04M 3/02

(52) U.S. Cl. CPC H04M 3/02
USPC 455/567

(57) ABSTRACT

A method for controlling a portable apparatus used in a telecommunication network includes: detecting whether a user makes a phone call through the portable apparatus; and when it is detected that the user makes the phone call through the portable apparatus, preventing the portable apparatus from playing back an audio indication, where the audio indication is transmitted from a service provider within the telecommunication network before a person answers the phone call. An associated portable apparatus operating according to the method includes a wireless communication module and a control circuit. The wireless communication module is arranged to perform wireless communication, and the portable apparatus provides the user with a service of establishing a phone call connection by utilizing the wireless communication module. When it is detected that the user makes the phone call through the portable apparatus, the control circuit prevents the portable apparatus from playing back the audio indication.

### TECHNICAL FIELD

The present invention relates to information management regarding a phone call, and more particularly, to a method for controlling a portable apparatus used in a telecommunication network, and to an associated portable apparatus.

### BACKGROUND

As wireless communication technologies progress, and as mobile phones become smaller and more fashionable than those of years ago, many people have their own mobile phones handy for daily use. Typically, when making a phone call using a mobile phone implemented according to the related art, a user of the mobile phone may hear an audio indication transmitted from a service provider before the person whom the user is calling answers the phone call, and the audio indication can be referred to as the ringback tone. In a situation where a ringback tone replacement service is provided, the user of the mobile phone may hear a customized ringback tone such as an audio clip (e.g. a clip of music, or a portion of a song), where the customized ringback tone can be provided by the service provider, or can be provided by a third party through the service provider. However, some problems may occur. For example, the audio clip may be too noisy, causing the user to feel uncomfortable. In another example, the audio clip may be a clip of advertisement, causing the user to feel bothered. Thus, a novel method is required in order to prevent the user from being uncomfortable or bothered when making a phone call in the above situation.

### SUMMARY

It is therefore an objective of the claimed invention to provide a method for controlling a portable apparatus used in a telecommunication network, and to provide an associated portable apparatus, in order to solve the above-mentioned problems.

An exemplary embodiment of a method for controlling a portable apparatus used in a telecommunication network comprises: detecting whether a user makes a phone call through the portable apparatus; and when it is detected that the user makes the phone call through the portable apparatus, preventing the portable apparatus from playing back an audio indication, wherein the audio indication is transmitted from a service provider within the telecommunication network before a person answers the phone call.

An exemplary embodiment of an associated portable apparatus for being used in a telecommunication network comprises a wireless communication module and a control circuit. The wireless communication module is arranged to perform wireless communication, wherein the portable apparatus provides a user with a service of establishing a phone call connection by utilizing the wireless communication module. In addition, the control circuit detects whether the user makes a phone call through the portable apparatus, and when it is detected that the user makes the phone call through the portable apparatus, the control circuit prevents the portable apparatus from playing back an audio indication, wherein the audio indication is transmitted from a service provider within the telecommunication network before a person answers the phone call.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a portable apparatus for being used in a telecommunication network according to a first embodiment of the present invention.

FIG. 2 is a flowchart of a method for controlling a portable apparatus used in a telecommunication network according to one embodiment of the present invention.

FIGS. 3A-3D illustrate some implementation details of the method shown in FIG. 2 according to different embodiments of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

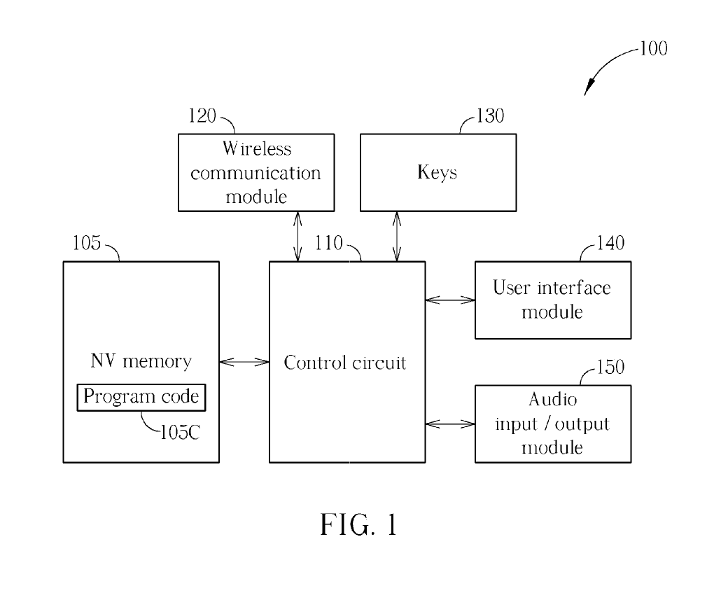

Please refer to FIG. 1, which illustrates a diagram of a portable apparatus 100 for being used in a telecommunication network according to a first embodiment of the present invention. The portable apparatus 100 of this embodiment is a portable electronic device equipped with multiple functionalities such as Personal Digital Assistant (PDA) and mobile phone functionalities. This is for illustrative purposes only, and is not meant to be a limitation of the present invention. According to a variation of this embodiment, the portable apparatus 100 can be a mobile phone. According to another variation of this embodiment, the portable apparatus 100 can be a PDA equipped with wireless communication capabilities.

As shown in FIG. 1, the portable apparatus 100 comprises a non-volatile (NV) memory 105, a control circuit 110, a wireless communication module 120, a plurality of keys 130 (e.g. hot keys), a user interface module 140, and an audio input/output module 150, where the NV memory 105 stores a program code 105C. For example, the program code 105C can be implemented with firmware or software. This is for illustrative purposes only, and is not meant to be a limitation of the present invention. According to some variations of this embodiment, the program code 105C can be embedded within the control circuit 110. In different variations of this embodiment, the control circuit 110 can be a hardware controller, a micro control unit (MCU), a micro processing unit (MPU), etc., respectively. According to some variations of this embodiment, the control circuit 110 is an MPU, and the NV memory 105 is replaced with a storage module such as a hard disk drive (HDD), where the program code 105C can be stored in the HDD.

According to this embodiment, the control circuit 110 is arranged to control operations of the portable apparatus 100. More particularly, the control circuit 110 executing the program code 105C controls the operations of the portable apparatus 100. In addition, the wireless communication module 120 is arranged to perform wireless communication, and provides the portable apparatus 100 with a plurality of wireless communication capabilities. As a result, the portable apparatus 100 (more particularly, the control circuit 110 therein) can provide a user with a service of establishing a phone call connection (more particularly, a connection over the telecommunication network between the calling party and the called party, which may respectively represent the user and the person supposed to answer the phone call made by the user) by utilizing the wireless communication module 120. For example, the wireless communication module 120 of this embodiment is capable of establishing a communication channel through an RF transceiver (not shown) of the wireless communication module 120. This is for illustrative purposes only, and is not meant to be a limitation of the present invention. According to some variations of this embodiment, the communication module 120 provides the portable apparatus 100 with 2nd Generation (2G) wireless communication capability such as Global System for Mobile Communications (GSM) communication capability, the so-called 2.5G wireless communication capability such as General Packet Radio Service (GPRS) communication capability, 3rd Generation (3G) wireless communication capability such as Wideband Code Division Multiple Access (WCDMA) communication capability, the so-called 3.5G wireless communication capability such as High-Speed Packet Access (HSPA) communication capability, and/or 4G wireless communication capability such as Worldwide Interoperability for Microwave Access (WIMAX) communication capability.

In this embodiment, the keys 130 (e.g. the hot keys mentioned above) can be arranged to trigger or control some functions of the portable apparatus 100. In addition, the user interface module 140 may comprise input devices such as a touch panel and a plurality of buttons. In practice, a liquid crystal display (LCD) of the touch panel is arranged to display information, and the user (i.e. the calling party in this embodiment) may read or view the information displayed by the LCD of the touch panel, and further control the portable apparatus 100 by using the touch panel and the buttons. This is for illustrative purposes only, and is not meant to be a limitation of the present invention. According to some variations of this embodiment, the buttons may comprise physical buttons and/or virtual buttons implemented with the touch panel. According to some variations of this embodiment, the keys 130 are not required since at least a portion of the buttons may replace the keys 130. Additionally, the audio input/output module 150 of this embodiment comprises audio processing and interfacing circuits, a microphone, and at least one speaker.

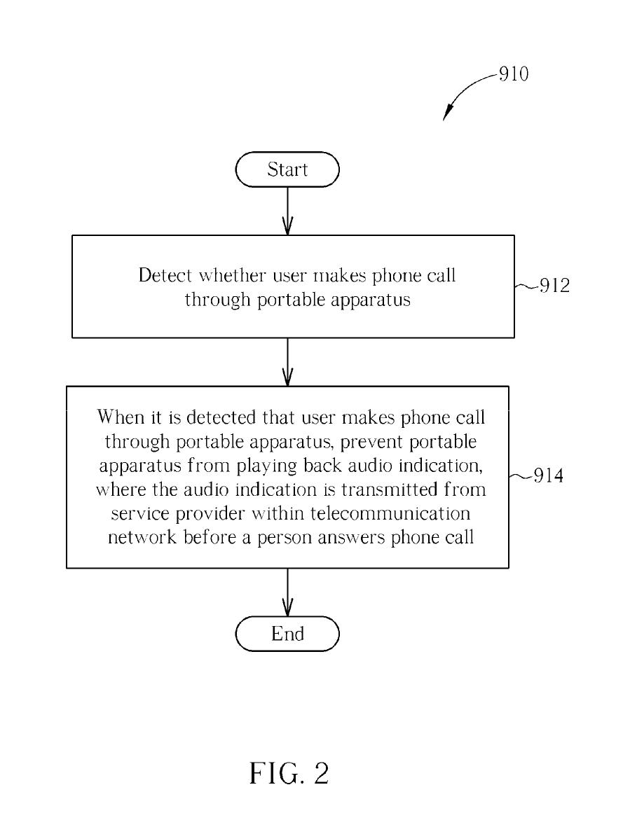

FIG. 2 is a flowchart of a method 910 for controlling a portable apparatus used in a telecommunication network according to an embodiment of the present invention. The method 910 shown in FIG. 2 can be applied to the portable apparatus 100, and more particularly, to the control circuit 110 executing the program code 105C. In addition, the method 910 shown in FIG. 2 can be implemented by utilizing the portable apparatus 100, and more particularly, by utilizing the control circuit 110 executing the program code 105C. The method is described as follows.

In Step 912, the control circuit 110 executing the program code 105C detects whether the user makes a phone call through the portable apparatus 100. In practice, the control circuit 110 executing the program code 105C can perform the above detection (i.e. the operation of detecting whether the user makes the phone call through the portable apparatus 100) by detecting whether the user completes his/her dialing. For example, when it is detected that the user dials a phone number and then presses a send button (e.g. one of the hot keys mentioned above), the control circuit 110 executing the program code 105C determines that the user makes the phone call through the portable apparatus 100. In another example, when it is detected that the user presses the send button mentioned above first and then dials a phone number completely, the control circuit 110 executing the program code 105C determines that the user makes the phone call through the portable apparatus 100.

In Step 914, when it is detected that the user makes the phone call through the portable apparatus 100, the control circuit 110 executing the program code 105C prevents the portable apparatus 100 from playing back an audio indication, where the audio indication is transmitted from a service provider within the telecommunication network before a person answers the phone call. For example, the audio indication can be the aforementioned ringback tone such as the ordinary ringback tone, without any ringback tone replacement service being provided. In another example, the audio indication can be the aforementioned customized ringback tone such as an audio clip (e.g. a clip of music, or a portion of a song).

As a result of the operations disclosed above, when making the phone call using the portable apparatus 100, the user can keep his/her mood good since the audio indication transmitted from the service provider before somebody answers the phone call will not be played back. Therefore, any of the related art problem that a noisy audio clip causes the user to feel uncomfortable and the related art problem that a clip of advertisement causes the user to feel bothered is no longer an issue.

In some embodiments, such as some variations of this embodiment, the control circuit 110 executing the program code 105C provides the user with at least one hint through the user interface module 140, allowing (more particularly, guiding) the user to designate at least one preferred audio clip by utilizing the user interface module 140, and plays at least one portion (e.g. a portion or all) of the preferred audio clip designated by the user before somebody (e.g. the person mentioned in Step 914) answers the phone call. In particular, the control circuit 110 executing the program code 105C allows (more particularly, guides) the user to designate the aforementioned at least one preferred audio clip for at least one entry (e.g. a person or a company) in a contact list by utilizing the user interface module 140, and plays at least one portion (e.g. a portion or all) of the aforementioned at least one preferred audio clip designated by the user before somebody answers the phone call, where the control circuit 110 executing the program code 105C may store the contact list in the NV memory 105 or another memory within/electronically connected to the portable apparatus 100. As a result, the control circuit 110 executing the program code 105C can utilize the preferred audio clip as a replacement for the audio indication mentioned in Step 914.

In practice, according to some of these variations, the control circuit 110 executing the program code 105C can utilize the audio input/output module 150 to input audio waves, audio signals, and/or audio information into the portable apparatus 100, and record the audio clip into a storage (e.g. the NV memory 105 or another memory within/electronically connected to the portable apparatus 100) for the user in advance. In addition, under the control of the control circuit 110 executing the program code 10.50, the audio input/output module 150 can output audio representatives (e.g. audio waves, audio signals, and/or audio information) of the audio clip, in order to play the audio clip. This is for illustrative purposes only, and is not meant to be a limitation of the present invention. According to some of these variations, the audio clip can be recorded in advance by using a microphone of another device, or by using some device(s) having audio-synthesizing functions, or by using some device(s) having audio-receiving functions and/or audio-processing functions.

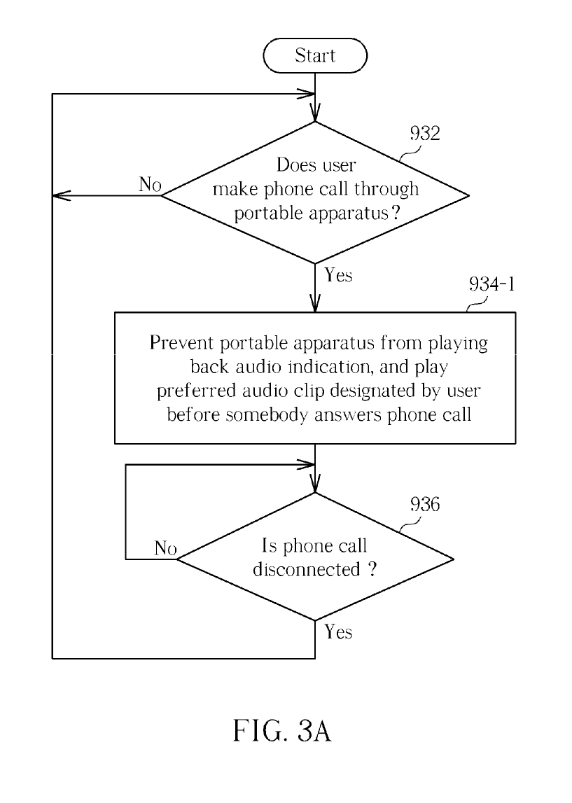

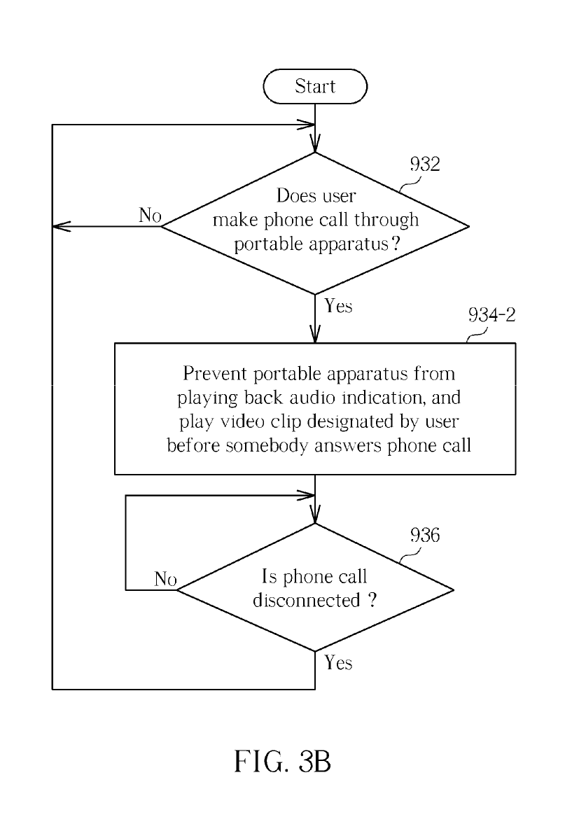

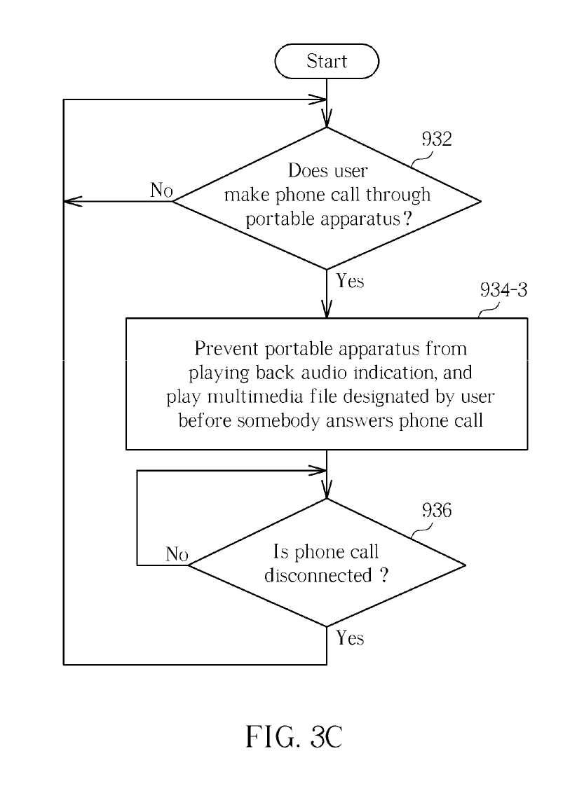

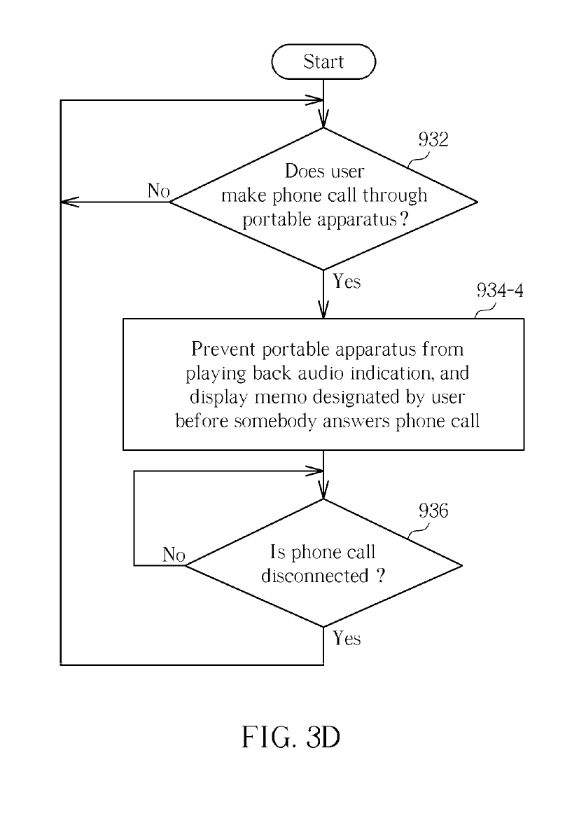

FIG. 3A illustrates some implementation details of the method 910 shown in FIG. 2 according to an embodiment of the present invention.

In Step 932, the control circuit 110 executing the program code 105C detects whether the user makes the phone call through the portable apparatus 100. When it is detected that the user makes the phone call through the portable apparatus 100, Step 934-1 is entered; otherwise, Step 932 is re-entered.

In Step 934-1, the control circuit 110 executing the program code 105C prevents the portable apparatus 100 from playing back the audio indication mentioned in Step 914, and plays a preferred audio clip designated by the user (e.g. the aforementioned at least one preferred audio clip designated by the user, and more particularly, the aforementioned at least one preferred audio clip designated for the aforementioned at least one entry in the contact list) before somebody answers the phone call. For example, the control circuit 110 executing the program code 105C allows the user to record the preferred audio clip by utilizing the portable apparatus 100 in advance, where the control circuit 110 executing the program code 105C may record one or more preferred audio clips for being selected by the user, and more particularly, record the one or more preferred audio clips into a storage such as that mentioned above. In this embodiment, the preferred audio clip can be a clip of music.

In Step 936, the control circuit 110 executing the program code 105C detects whether the phone call is disconnected. When it is detected that the phone call is disconnected, Step 932 is re-entered; otherwise, Step 936 is re-entered.

Please note that, in addition to the clip of music mentioned above, examples of the preferred audio clip may further comprise varies kinds of audio memos (or memorandums). For example, the audio content of an audio memo can be “He (She) will be very angry.” In another example, the audio content of another audio memo can be “Smile! Smile! Smile!” In another example, the audio content of another audio memo can be “Check the buying list.”

According to some variations of the embodiment shown in FIG. 2, the control circuit 110 executing the program code 105C provides the user with at least one hint through the user interface module 140, allowing (more particularly, guiding) the user to designate at least one video clip by utilizing the user interface module 140, and plays at least one portion (e.g. a portion or all) of the video clip designated by the user before somebody (e.g. the person mentioned in Step 914) answers the phone call. In particular, the control circuit 110 executing the program code 105C allows (more particularly, guides) the user to designate the aforementioned at least one video clip for at least one entry (e.g. a person or a company) in a contact list by utilizing the user interface module 140, and plays at least one portion (e.g. a portion or all) of the aforementioned at least one video clip designated by the user before somebody answers the phone call, where the control circuit 110 executing the program code 105C may store the contact list in the NV memory 105 or another memory within/electronically connected to the portable apparatus 100. As a result, the control circuit 110 executing the program code 105C can utilize the video clip as a replacement for the audio indication mentioned in Step 914.

In practice, according to some of these variations, the control circuit 110 executing the program code 105C can utilize a camera connected to or installed within the portable apparatus 100 to input/capture images into the portable apparatus 100 and utilize the audio input/output module 150 to input audio waves, audio signals, and/or audio information into the portable apparatus 100, and record the video clip into a storage (e.g. the NV memory 105 or another memory within/electronically connected to the portable apparatus 100) for the user in advance. In addition, under the control of the control circuit 110 executing the program code 105C, the user interface module 140 (more specifically, the LCD of the touch panel mentioned above in this embodiment) can display one or more images of the video clip and the audio input/output module 150 can output audio representatives (e.g. audio waves, audio signals, and/or audio information) of audio portion(s) of the video clip, in order to play the video clip. This is for illustrative purposes only, and is not meant to be a limitation of the present invention. According to some of these variations, the video clip can be recorded in advance by using a camera of another device, or by using some device(s) having video production functions, or by using some device(s) having image-capturing functions, image generation functions, and/or image-processing functions.

FIG. 3B illustrates some implementation details of the method 910 shown in FIG. 2 according to an embodiment of the present invention.

In Step 932, the control circuit 110 executing the program code 105C detects whether the user makes the phone call through the portable apparatus 100. When it is detected that the user makes the phone call through the portable apparatus 100, Step 934-2 is entered; otherwise, Step 932 is re-entered.

In Step 934-2, the control circuit 110 executing the program code 105C prevents the portable apparatus 100 from playing back the audio indication mentioned in Step 914, and plays a video clip designated by the user (e.g. the aforementioned at least one video clip designated by the user, and more particularly, the aforementioned at least one video clip designated for the aforementioned at least one entry in the contact list) before somebody answers the phone call. For example, the control circuit 110 executing the program code 105C allows the user to record the video clip by utilizing the portable apparatus 100 in advance, where the control circuit 110 executing the program code 105C may record one or more video clips for being selected by the user, and more particularly, record the one or more video clips into a storage such as that mentioned above.

In Step 936, the control circuit 110 executing the program code 105C detects whether the phone call is disconnected. When it is detected that the phone call is disconnected, Step 932 is re-entered; otherwise, Step 936 is re-entered.

According to some variations of the embodiment shown in FIG. 2, the control circuit 110 executing the program code 105C provides the user with at least one hint through the user interface module 140, allowing (more particularly, guiding) the user to designate at least one multimedia file by utilizing the user interface module 140, and plays at least one portion (e.g. a portion or all) of the multimedia file designated by the user before somebody (e.g. the person mentioned in Step 914) answers the phone call. In particular, the control circuit 110 executing the program code 105C allows (more particularly, guides) the user to designate the aforementioned at least one multimedia file for at least one entry (e.g. a person or a company) in a contact list by utilizing the user interface module 140, and plays at least one portion (e.g. a portion or all) of the aforementioned at least one multimedia file designated by the user before somebody answers the phone call, where the control circuit 110 executing the program code 105C may store the contact list in the NV memory 105 or another memory within/electronically connected to the portable apparatus 100. As a result, the control circuit 110 executing the program code 105C can utilize the multimedia file as a replacement for the audio indication mentioned in Step 914.

FIG. 3C illustrates some implementation details of the method 910 shown in FIG. 2 according to an embodiment of the present invention.

In Step 932, the control circuit 110 executing the program code 105C detects whether the user makes the phone call through the portable apparatus 100. When it is detected that the user makes the phone call through the portable apparatus 100, Step 934-3 is entered; otherwise, Step 932 is re-entered.

In Step 934-3, the control circuit 110 executing the program code 105C prevents the portable apparatus 100 from playing back the audio indication mentioned in Step 914, and plays a multimedia file designated by the user (e.g. the aforementioned at least one multimedia file designated by the user, and more particularly, the aforementioned at least one multimedia file designated for the aforementioned at least one entry in the contact list) before somebody answers the phone call. For example, the control circuit 110 executing the program code 105C provides the user with at least one hint through the user interface module 140, allowing the user to retrieve the multimedia file from the Internet or from a personal computer (PC) by utilizing the portable apparatus 100 in advance, where the control circuit 110 executing the program code 105C may store one or more multimedia files for being selected by the user, and more particularly, store the one or more multimedia files into a storage such as that mentioned above.

In Step 936, the control circuit 110 executing the program code 105C detects whether the phone call is disconnected. When it is detected that the phone call is disconnected, Step 932 is re-entered; otherwise, Step 936 is re-entered.

According to some variations of the embodiment shown in FIG. 2, the control circuit 110 executing the program code 105C provides the user with at least one hint through the user interface module 140, allowing (more particularly, guiding) the user to designate reference information such as at least one memo by utilizing the user interface module 140, and under control of the control circuit 110 executing the program code 105C, the user interface module 140 (more specifically, the LCD of the touch panel mentioned above in this embodiment) can start displaying the reference information designated by the user before somebody (e.g. the person mentioned in Step 914) answers the phone call. In particular, the control circuit 110 executing the program code 105C allows (more particularly, guides) the user to designate the reference information for at least one entry (e.g. a person or a company) in a contact list by utilizing the user interface module 140, and control the user interface module 140 to start displaying the reference information designated by the user before somebody answers the phone call, where the control circuit 110 executing the program code 105C may store the contact list in the NV memory 105 or another memory within/electronically connected to the portable apparatus 100. Thus, under the control of the control circuit 110, the user interface module 140 can be arranged to display the reference information regarding the called party of the phone call. As a result, the control circuit 110 executing the program code 105C can utilize the reference information as a replacement for the audio indication mentioned in Step 914. Please note that the reference information of these variations can be regarded as visual reference information.

In these variations, the reference information mentioned above typically represents the information that the user may consider valuable regarding the called party of this phone call, such as the person supposed to answer the phone call, and can be utilized for reminding the user of what happened or something important. As a result, the user may feel well prepared when making the phone call.

FIG. 3D illustrates some implementation details of the method 910 shown in FIG. 2 according to an embodiment of the present invention.

In Step 932, the control circuit 110 executing the program code 105C detects whether the user makes the phone call through the portable apparatus 100. When it is detected that the user makes the phone call through the portable apparatus 100, Step 934-4 is entered; otherwise, Step 932 is re-entered.

In Step 934-4, the control circuit 110 executing the program code 105C prevents the portable apparatus 100 from playing back the audio indication mentioned in Step 914, and controls the user interface module 140 to display a memo designated by the user (e.g. the aforementioned at least one memo designated by the user, and more particularly, the aforementioned at least one memo designated for the aforementioned at least one entry in the contact list) before somebody answers the phone call. For example, the control circuit 110 executing the program code 105C allows the user to keyin/enter (or write down, through the touch panel mentioned above, if this functionality is supported) the memo by utilizing the portable apparatus 100 in advance, where the control circuit 110 executing the program code 105C may store one or more memos for being selected by the user, and more particularly, store the one or more memos into a storage such as that mentioned above.

In Step 936, the control circuit 110 executing the program code 105C detects whether the phone call is disconnected. When it is detected that the phone call is disconnected, Step 932 is re-entered; otherwise, Step 936 is re-entered.

Please note that, in addition to the memo(s) mentioned above, examples of the aforementioned reference information may further comprise at least one special day associated to the called party of the phone call (e.g. the birthday of the called party such as the person supposed to answer the phone call), at least one document associated to the called party of the phone call, and representative(s) of the aforementioned at least one document associated to the called party of the phone call. For example, the document associated to the called party can be an e-mail (or electronic mail) received from or sent to the called party such as the person supposed to answer the phone call, and the representative of the document can be an e-mail record. In another example, the document associated to the called party can be a short message received from or sent to the called party such as the person supposed to answer the phone call, and the representative of the document can be a short message record, where the short message can be received or sent through the Short Message Service (SMS).

According to some embodiments, such as some variations of the embodiments/variations disclosed above, the control circuit 110 executing the program code 105C provides the user with at least one hint through the user interface module 140, allowing (more particularly, guiding) the user to designate the aforementioned at least one preferred audio clip, the aforementioned at least one video clip, the aforementioned at least one multimedia file, and/or the aforementioned reference information for at least one entry in a contact list such as that mentioned above by utilizing the user interface module 140. For example, the control circuit 110 executing the program code 105C plays at least one portion of one of the aforementioned at least one preferred audio clip, the aforementioned at least one video clip, and the aforementioned at least one multimedia file before somebody answers the phone call. In another example, under control of the control circuit 110 executing the program code 105C, the user interface module 140 is arranged to start displaying the reference information before somebody answers the phone call. Similar descriptions for these embodiments are not repeated in detail here.

As a result of at least a portion of the operations disclosed above, such as those disclosed in the embodiments shown in FIGS. 3C-3D (and associated variations), and even those disclosed in the embodiment shown in FIG. 3B, when making the phone call using the portable apparatus 100, the user can see much more displayed information than that displayed on the display module of the mobile phone implemented according to the related art. Therefore, in contrast to the related art, the present invention method and the associated portable apparatus 100 can help the user to feel well prepared when making the phone call, bringing the user a comfortable communication experience.

It is an advantage of the present invention that the present invention method and the associated portable apparatus can prevent the user from hearing any customized ringback tone before somebody answers the phone call, and therefore, the related art problems that the user may feel uncomfortable or bothered due to the customized ringback tone will no longer be an issue. In addition, the present invention method and the associated portable apparatus can replace the aforementioned audio indication (e.g. the ordinary ringback tone, or the customized ringback tone) with at least one preferred audio clip (or at least one video clip), bringing the user a mood good. Additionally, the present invention method and the associated portable apparatus can provide the user with at least one preferred audio clip, at least one video clip, at least one multimedia file, or various kinds of reference information before somebody answers the phone call, in order to help the user be well prepared when making the phone call, bringing the user a comfortable communication experience.

Those skilled in the art will readily observe that numerous modifications and alterations of the device and method may be made while retaining the teachings of the invention.

1. A method for controlling a portable apparatus used in a telecommunication network, the method comprising:
detecting whether a user makes a phone call through the portable apparatus; and
when it is detected that the user makes the phone call through the portable apparatus, preventing the portable apparatus from playing back an audio indication, wherein the audio indication is transmitted from a service provider within the telecommunication network before a person answers the phone call.

2. The method of claim 1, further comprising:
playing at least one portion of at least one preferred audio clip designated by the user before somebody answers the phone call.

3. The method of claim 1, further comprising:
playing at least one portion of at least one video clip designated by the user before somebody answers the phone call.

4. The method of claim 1, further comprising:
playing at least one portion of at least one multimedia file designated by the user before somebody answers the phone call.

5. The method of claim 1, further comprising:
starting displaying reference information designated by the user before somebody answers the phone call.

6. The method of claim 5, wherein the reference information comprises at least one memo, at least one special day associated to a called party of the phone call, at least one document associated to the called party of the phone call, and/or representative(s) of at least one document associated to the called party of the phone call.

7. The method of claim 1, further comprising:
providing the user with at least one hint through a user interface module, allowing the user to designate at least one preferred audio clip, at least one video clip, at least one multimedia file, and/or reference information by utilizing the user interface module.

8. The method of claim 7, further comprising:
playing at least one portion of one of the at least one preferred audio clip, the at least one video clip, and the at least one multimedia file before somebody answers the phone call.

9. The method of claim 7, further comprising:
starting displaying the reference information before somebody answers the phone call.

10. The method of claim 1, further comprising:
providing the user with at least one hint through a user interface module, allowing the user to designate at least one preferred audio clip, at least one video clip, at least one multimedia file, and/or reference information for at least one entry in a contact list by utilizing the user interface module.

11. A portable apparatus for being used in a telecommunication network, the portable apparatus comprising:
a wireless communication module arranged to perform wireless communication, wherein the portable apparatus provides a user with a service of establishing a phone call connection by utilizing the wireless communication module; and
a control circuit, wherein the control circuit detects whether the user makes a phone call through the portable apparatus, and when it is detected that the user makes the phone call through the portable apparatus, the control circuit prevents the portable apparatus from playing back an audio indication, wherein the audio indication is transmitted from a service provider within a telecommunication network before a person answers the phone call.

12. The portable apparatus of claim 11, wherein the control circuit plays at least one portion of at least one preferred audio clip designated by the user before somebody answers the phone call.

13. The portable apparatus of claim 11, wherein the control circuit plays at least one portion of at least one video clip designated by the user before somebody answers the phone call.

14. The portable apparatus of claim 11, wherein the control circuit plays at least one portion of at least one multimedia file designated by the user before somebody answers the phone call.

15. The portable apparatus of claim 11, further comprising:
a user interface module arranged to display information, wherein under control of the control circuit, the user interface module is arranged to start displaying reference information designated by the user before somebody answers the phone call.

16. The portable apparatus of claim 15, wherein the reference information comprises at least one memo, at least one special day associated to a called party of the phone call, at least one document associated to the called party of the phone call, and/or representative(s) of at least one document associated to the called party of the phone call.

17. The portable apparatus of claim 11, further comprising:
a user interface module arranged to display information, wherein the control circuit provides the user with at least one hint through the user interface module, allowing the user to designate at least one preferred audio clip, at least one video clip, at least one multimedia file, and/or reference information by utilizing the user interface module.

18. The portable apparatus of claim 17, wherein the control circuit plays at least one portion of one of the at least one preferred audio clip, the at least one video clip, and the at least one multimedia file before somebody answers the phone call.

19. The portable apparatus of claim 17, wherein under control of the control circuit, the user interface module is arranged to start displaying the reference information before somebody answers the phone call.

20. The portable apparatus of claim 11, further comprising:
a user interface module arranged to display information, wherein the control circuit provides the user with at least one hint through the user interface module, allowing the user to designate at least one preferred audio clip, at least one video clip, at least one multimedia file, and/or reference information for at least one entry in a contact list by utilizing the user interface module.
